(19) United States
(12) Patent Application Publication
(10) Pub. No.: US 2017/0228198 A1
(43) Pub. Date: Aug. 10, 2017

(54) SELECTING A PRINTER

(71) Applicant: HEWLETT-PACKARD DEVELOPMENT COMPANY, L.P., Houston, TX (US)

(72) Inventors: ARUN KOORMAMTHARAYIL, Bangalore (IN); SAJAL KUM DAS, Bangalore (IN); SREEKUMAR ASHOK, Bangalore (IN)

(21) Appl. No.: 15/016,563

(22) Filed: Feb. 5, 2016

(51) Int. Cl. G06F 3/12

(52) U.S. Cl. CPC G06F 3/126; G06F 3/1204; G06F 3/1256; G06F 3/1292

(57) ABSTRACT

A technique includes, in an electronic device, in response to a print job, identifying active printers; and in the electronic device, prioritizing the identified active printers to process the print job based at least in part on a location for the electronic device and statuses associated with the printers.

### BACKGROUND

An electronic device, such as a smartphone, laptop computer or desktop computer, may have multiple installed printer drivers to handle print jobs for the device. The printer drivers correspond to printers that may be potentially available, and one of printers may be designated as the default printer for the electronic device. When a user of the electronic device initiates a print job, the user may acknowledge selection of the default printer or scroll through a graphical user interface (GUI) to select another printer to handle the print job.

### BRIEF DESCRIPTION OF THE DRAWINGS

FIG. 1 is a schematic diagram of a printing environment according to an example implementation.

FIGS. 2 and 3 are flow diagrams depicting techniques to select a printer to process a print job for an electronic device according to example implementations.

FIGS. 4A and 4B flow diagrams depicting techniques to determine proximities between an electronic device and candidate printers according to an example implementation.

FIGS. 5A, 5B, 5C, 5D and 5E depict images generated by a graphical user interface (GUI) an electronic device according to an example implementation.

FIG. 6 illustrates selective routing/re-routing of a print job according to an example implementation.

FIG. 7 is a schematic diagram of the electronic device according to an example implementation.

FIG. 8 is a schematic diagram of the printer selection engine according to an example implementation.

### DETAILED DESCRIPTION

An electronic device (a physical machine, such as a desktop computer, a tablet computer, a smartphone, a laptop computer, for example) may have a number of installed printer drivers that correspond to printers that may be available for processing a print job for the electronic device. When the electronic device generates a print job, the electronic device may select a predesignated default printer irrespective of potentially many factors, which may affect which available printer is optimally the best choice for processing the print job. For example, the electronic device may be a mobile, or portable, electronic device, and as such, the location of the mobile device may be a factor in selecting the appropriate printer (i.e., the printers that are actually available for handling the print job may depend on the location of the printers and the location of the electronic device). As another example, selection of the appropriate printer may depend on the particular print job requirements (color palette, resolution, and so forth), and may be more optimally handled by an available printer other than a default printer. As yet another example, a printer that may be otherwise selected may be less desirable due to printer errors such as the printer currently being out of paper or toner, the printing operation being halted due to a paper jam, the printer having a relatively large number of pending print jobs in its print queue, and so forth.

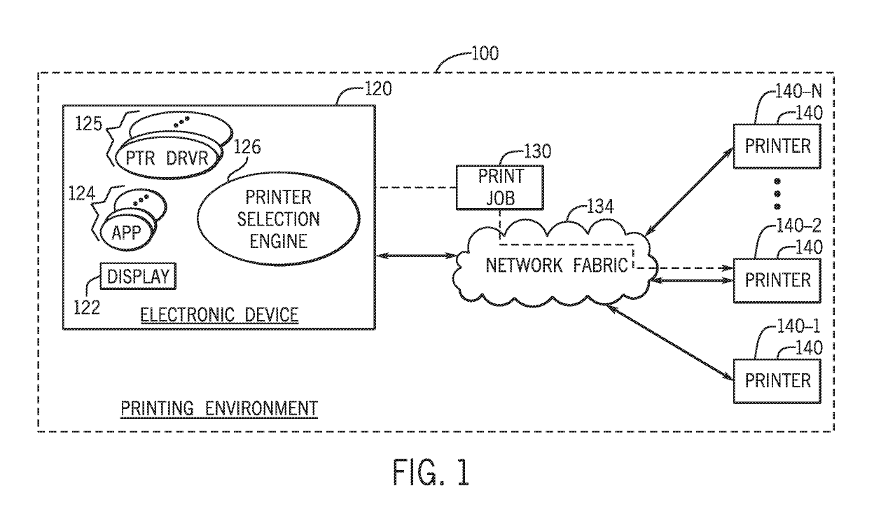

Referring to FIG. 1, in accordance with example implementations, an electronic device 120 may, for a given print job 130, be part of a printing environment 100 in which one or multiple printers 140 (N printers 140-1, 140-2 . . . 140-N being depicted in FIG. 1) are potentially available for processing the print job 130. In this context, a “printer” is a physical machine (a laser printer, an ink jet printer, a plotter, a three-dimensional (3-D) printer, a digital copier, and so forth); and a “print job” contains print job data (data arranged in a PCL-3 file, for example), which describes a tangible output to be produced by the printer 140, such as a document with text and/or graphics, a 3-D object, a computer aided design (CAD) drawing, and so forth. The print data is in a format that is recognized by the printer 140 and may contain, for example, data representing the content of the printer's tangible output and control codes to control the actions by the printer 140 to produce the tangible output. A given printer 140 may be associated with a printer driver 124, which is a set of machine executable instructions that may be installed on the electronic device 120 for purposes of generating the appropriate print data (data in certain printer command language (PCL) format, for example) for the printer 140.

In general, the electronic device 120 executes one or multiple applications 124, and as a result of this execution, the electronic device 120 may produce content to be printed, thereby initiating a print job 130. In accordance with example implementations, the electronic device 120 selects a printer 140 to process the print job 130 based on criteria other than the printer 140 being merely designated as being the default printer 140 for the device 120. In particular, a printer selection engine 126 of the electronic device 120 ranks the printers 140 to, in accordance with example implementations, process the print job 130 based on criteria discussed herein, and the printer selection engine 126 selects one of the printers 140 to process the print job 130 based on this ranking. As discussed herein, the user may ultimately confirm or override the engine's selection of the printer 140. Regardless of the specific process, a printer 140 is ultimately selected to handle the print job 130 (such as printer 140-2 for the example of FIG. 1), and the electronic device 120 uses the printer driver 125 that is associated with the selected printer 140 to generate the print data for the print job 130, communicate with the selected printer 140 to route the print job 130 to the printer 140 and ultimately confirm successful processing of the print job 130 by the printer 140.

The printer selection engine 126 ranks and selects the printers 140 based a number of criteria that identify whether a given printer 140 may be more suitable for handling a given print job 130 than another printer 140. For example, although connected to (i.e., in communication with) the electronic device 120, a given printer 140 may be disposed at a relatively far distance away from the electronic device 120 (and from the user of the electronic device). In this manner, by selecting the printer 140-1 (as an example), the user may walk up two floors to retrieve a printed document, as compared to walking down the hallway to retrieve a printed document from the printer 140-2. Therefore, based on distance alone, the printer selection engine 126 may rank the printer 140-2 ahead of the printer 140-1 for handling the print job 130.

As another example, a given printer 140 may be out of paper, out of toner, or, in general, be subject to an error that makes the printer 140 at least temporarily unavailable. Therefore, the printer selection engine 126 may at least temporarily assign a lower rank to this printer 140.

As another example, the print job 130 may be associated with printing a color document, but a given printer 140 may be a monochrome printer, or the given printer 140 may be a color printer but its color printing cartridge may be depleted. As such, the printer 140 may be at least temporarily be unable to handle a print job 130 directed to printing the color document; and as such, the printer selection engine 126 may assign a relatively low rank to this printer 140 or filter out the printer 140 as being a candidate for the print job 130.

As yet another example, a given printer 140 may be relatively close to the electronic device 120, capable of handling the specifics of the print job and online (i.e., not offline, or unavailable due to an error or fault). However, this printer 140 may have a relatively large workload (a relatively large number of pending print jobs or one or multiple relatively large print jobs), the printer's pages per minute (ppm) capability may be too low (i.e., the printer may be a low-end printer, relative to the printer job) or may be of the type that is inferior for the job (a slower inkjet printer versus a faster laser printer, for example). As such, a printer 140 that is farther away may be more suitable for handling the print job 130, and the printer selection engine 126 may rank these two printers 140 accordingly.

As examples, the electronic device 120 may be a relatively stationary device, such as a desktop computer, or the electronic device 120 may be a more mobile device, such as a laptop computer, a tablet computer, a smartphone, and so forth. As depicted in FIG. 1, the electronic device 120 may, in general, be coupled to network fabric 134, which allows the electronic device 120 to be potentially connected to one or multiple printers 140; and the number of printers 140 that are connected to the electronic device 120 may change over time due to such factors as printers 140 coming on and off line and the electronic device 120 changing locations. As examples, the network fabric 134 may be a local area network (LAN) fabric, a wide local area network (WLAN) fabric, wireless fabric, cellular fabric, a combination of one or more of these network fabrics, and so forth, depending on the particular implementation.

In accordance with example implementations, the printer selection engine 126 is invoked, or triggered, by an application 124 initiating a print job 130. For example, a user of the electronic device 120 may select a “PRINT” button on a graphical user interface (GUI) of an application 124, to cause the application 124 to invoke the printer selection engine 126.

In response to being invoked, in accordance with example implementations, the printer selection engine 126 identifies candidate printers 140 for the print job 130; ranks, or prioritizes, the identified candidate printers 140; and presents the ranked printers 140 in a GUI on a display 122 of the electronic device 120. The printer selection engine 126 may then select the top ranked printer 140 so that the print job 130 may be routed to the selected printer 140.

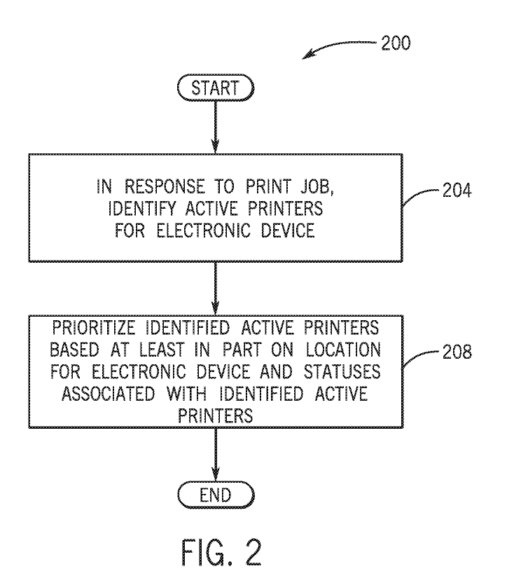

Referring to FIG. 2 in conjunction with FIG. 1, in accordance with example implementations, the printer selection engine 126 may generally perform a technique 200. Pursuant to the technique 200, the printer selection engine 126, in response to a print job, identifies (block 204) active printers based at least in part on a location for the electronic device. In this context, an “active” printer refers to a printer to that is currently accessible by the electronic device 120 (i.e., the electronic device 120 sees the printer as being available on a network to which the electronic device 120 is connected). A “location” refers to a position, such as a physical position (global positioning satellite (GPS) coordinates, office number, street address, and so forth) or a network position (a network subnet address, for example). Moreover, the “location for the electronic device” refers to a current location of the electronic device or a future location of the electronic device.

To identify the candidate active printers 140, the printer selection engine 126 may search through the Internet Protocol (IP) addresses of printers 140 whose printer drivers have been installed on the electronic device 120 of purposes of attempting to communicate with these printers 140 to determine whether the printers 140 are presently connected to the electronic device 120. For the case in which the location for the electronic device 120 is the device's current location, the printer selection engine 126 may identify candidate active printers 140 whose corresponding drivers have not been installed by communicating with nearby network devices (network devices in the same subnet as the electronic device 120, for example) to determine whether the devices are associated with printers and possibly retrieving information about any such printers. For the case in which the location for the electronic device 120 is the device's future location, the printer selection engine 126 may identify candidate active printers 140 whose corresponding drivers have not been installed by communicating with network devices near the future location (network devices in the same subnet as the future location of the electronic device, for example) to determine whether the devices are associated with printers and possibly retrieving information about any such printers.

In accordance with example implementations, the printer selection engine 140 may identify candidate active printers 140 based on one or multiple user preferences. For example, through a GUI interface of the electronic device 120, a user may store predetermined list(s) of printers 140 sorted according to locations for the device 120. In some implementations, the preferences may specify a potential list of printers 140 independent of the location for the electronic device 120. The printer selection engine 126 may then attempt to communicate with the printers 140 identified by the user preferences for purposes of determining which printers 140 are available, the statuses of these printers 140, and so forth.

Regardless of how the printers 140 are identified, pursuant to the technique 200, the printer selection engine 126 prioritizes (block 208) the identified active printers 140 based at least in part on a location for the electronic device 120 and statuses associated with the printers 140. In accordance with some implementations, the statuses may include, as examples, an error status indicating the printer is available or unavailable to print, a hardware error status indicating the printer is experiencing a hardware fault (the printer is out of toner, the printer has a paper jam, and so forth) or a status representing that the printer is experiencing a media fault (the printer is out of paper, for example).

The printer selection engine 126 may present the prioritized list through a GUI to the user so that the user may select the printer 140 to process the print job 130 according to rank. In accordance with some implementations, the printer selection engine 126 may automatically select the highest priority printer 140 (i.e., printer 140 having the highest rank) and allow a preset time for the user to confirm/override the selection until the printer selection engine 126 automatically proceeds to route the print job 130 to the selected printer 140.

As described herein, the printer selection engine 126 may also determine locations for the identified printers and use these locations for purposes of prioritizing the identified active printers. At the printer installation time, the location information of the printer may be programmed into the printer memory for retrieval as needed by query message from electronic devices. In accordance with example implementations, the updated printer location and configuration information may be stored in a cloud server, which can be easily accessed by the electronic device to know the present location of the printer from anywhere. Moreover, as further described herein, a printer may derive its location using information received by a global positioning satellite (GPS) radio of the printer.

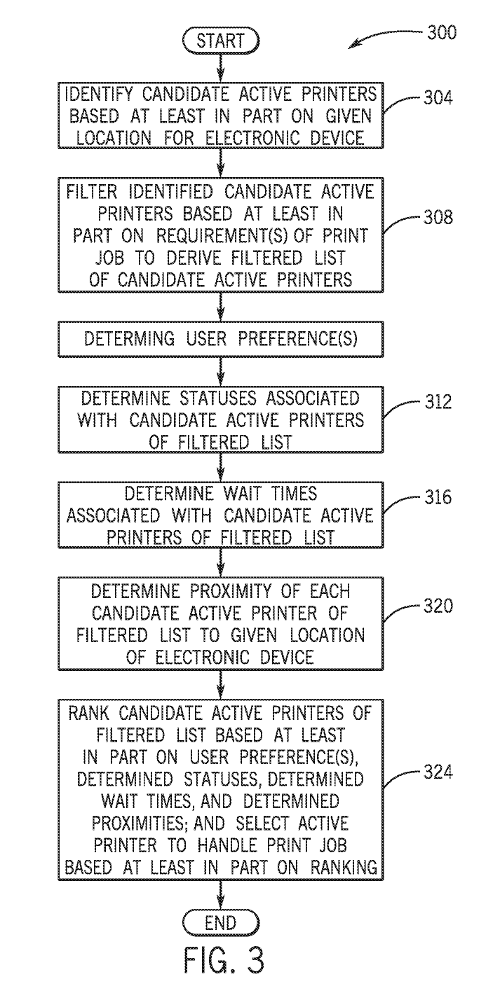

As a more specific example, in accordance with some implementations, the printer selection engine 126 may perform a technique 300 that is depicted in FIG. 3. Referring to FIG. 3 in conjunction with FIG. 1, pursuant to the technique 300, the printer selection engine 126 identifies (block 304) candidate active printers 140 to process the print job 130 based at least in part on a given location for the electronic device 120; and the printer selection engine 126 filters (block 308) candidate active printers 140 from the identified candidate active printers 140 based at least in part on requirements of the print job to derive a filtered list of candidate active printers 140. For example, if the print job has an associated resolution or ink color requirement, then the printer selection engine 126 culls any printer(s) 140 that cannot meet this requirement.

According to the technique 300, the printer selection engine 126 may also determine (block 310) one or multiple user preferences, determine (block 312) statuses associated with the candidate active printers of the filtered list and determine (block 316) wait times associated with the candidate active printers of the filtered list. In this context, a “wait time” associated with a printer refers to a time associated with completing the print job 130. As examples, in accordance with example implementations, the wait time associated with a printer may be based on the number of documents pending in the printer's queue, the page per minute (ppm) capacity of the printer, a combination of these factors, and so forth. The printer selection engine 126 may also determine (block 320) the proximity of each candidate active printer 140 of the filtered list to the given location for the electronic device 120. In this context, the “proximity” refers to a measure of how close the active printer 140 is to the given location, such as a physical distance separating the device 120 and the printer 140; a network distance (within the same network subnet, for example), a number of offices between the device 120 and the printer 140, a number of floors between the device 120 and the printer 140, and so forth. Pursuant to the technique 300, the printer selection engine 126 subsequently ranks the candidate active printers based at least in part on the determined user preference(s), statuses, wait times and proximities, and then selects the active printer 140 to process the print job 130 based at least in part on the ranking, pursuant to block 324.

As a more specific example, the location for the electronic device 120 may be the device's current physical location, and the printer selection engine 126 may identify three active printers 140 that are currently accessible to the electronic device 120 (i.e., printers 140 to which the device 126 may communicate). The three identified printers 140 may be located different physical distances from the electronic device's current location, and the printer selection engine 126 may display the following table in a GUI of the electronic device 120:

TABLE 1

| | Device | Approx. Time | Physical |
|---|---|---|---|
| Printer # | Status | to Start Print | Distance |
| 01 | Available | 0 Seconds | 20 meters |
| 02 | Available | 0 Seconds | 25 meters |
| 03 | Unavailable | 0 Seconds | 15 meters |

Thus, for this example, the printer selection engine 126 may select Printer #1, which is the closest available printer 140 that is connected to the electronic device 120 and is capable of handling the job requirements of the print job 130.

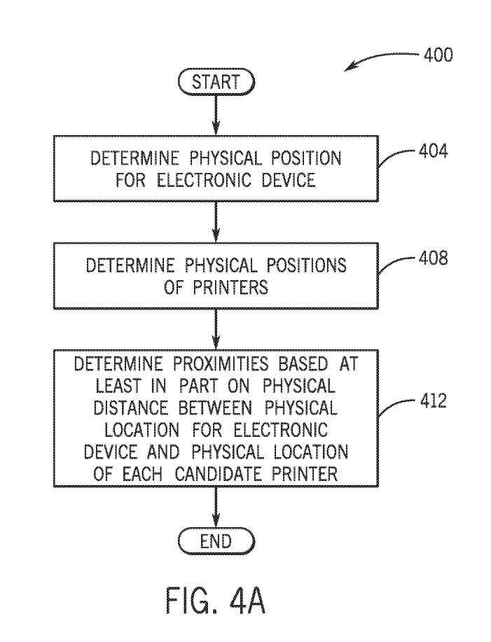

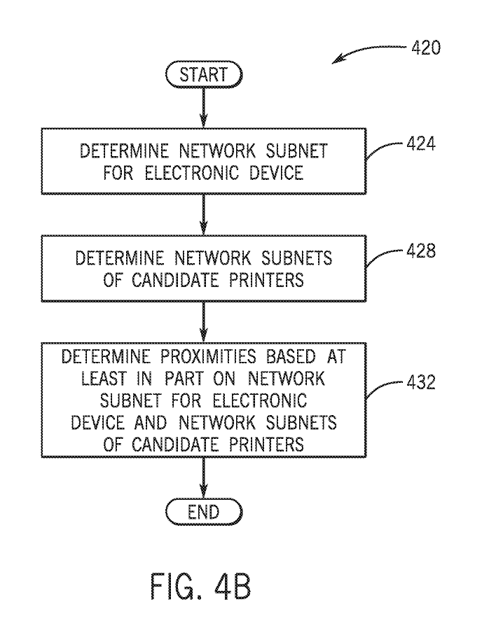

In accordance with example implementations, the location for the electronic device 120 may be the current, physical location of the device 120; and the printer selection engine 126 may perform a technique 400 that is depicted in FIG. 4A for purposes of determining proximities between the electronic device 120 and the candidate printers 140. More specifically, referring to FIG. 4A in conjunction with FIG. 1, pursuant to the technique 400, the user selection engine 126 may determine (block 404) a current physical position of the electronic device 120. As an example, the user selection engine 126 may use a global positioning satellite (GPS) radio of the electronic device 120 for purposes of identifying geographical (longitude and latitude) coordinates of the electronic device 120. Pursuant to the technique 400, the user selection engine 126 may further determine (block 408) the physical positions of the candidate printers 140. For example, in accordance with some implementations, one or multiple printers 140 of the candidate printers 140 may be programmed with physical locations (programmed with GPS coordinates, for example). Thus, the printer selection engine 126 may communicate with the candidate printers 140 for purposes of receiving data (provided by the printers 140), which represents the printer's physical locations. In accordance with further example implementations, a given printer 140 may have a GPS radio, which allows the printer to determine its physical location; and accordingly, the printer 140 may provide its physical location derived from its GPS radio to the printer selection engine 126. Next, pursuant to the technique 400, the printer selection engine 126 may determine (block 412) physical distances between the electronic device 120 and the candidate printers 140 for purposes of determining the proximities used in its ranking of the printers 140.

In accordance with some implementations, the electronic device 120 may have a relatively low energy radio, such as a Bluetooth radio (a radio compliant with the IEEE 802.15.1 standard, for example), which is associated with a relatively small distance communications (distances less than 10 meters, for example). The electronic device 120 may use such a low energy radio to determine physical proximities of nearby printers, as the strongest signal indicates the closest printer.

As noted above, the location for the electronic device 120 may be a location other than the current, physical location of the device. For example, in accordance with some implementations, the GUI provided by the user selection engine 126 may allow a user to select the location for the electronic device 120, such as the current physical location of the electronic device 120 or another future location for the device 120. For example, the electronic device 120 may be a mobile device, and the user may be traveling to home or the airport from the office. Therefore, via the appropriate setting of the printer selection engine 126, the user may configure the engine 126 to consider the location of the electronic device for printing purposes to be a future location of the user, such as the user's home, business, airport, meeting venue, or other location.

In accordance with further example implementations, the proximities between the location for the electronic device 120 and the candidate printer locations may be determined based on relative network locations. For example, referring to FIG. 4B, in accordance with some implementations, the printer selection engine 126 may determine (block 424) a network subnet associated with the electronic device 120. For example, in accordance with some implementations, the printer selection engine 126 may determine a subnet mask identification (ID) for the electronic device 120 and determine (block 428) one or multiple network subnets for the candidate printers 140. For example, pursuant to block 428, the printer selection engine 126 may determine a subnet mask ID for each of the candidate printers. It is further noted that the network subnet for the electronic device 120 (as determined in block 424) may be the network subnet currently for the electronic device 120 or a future network subnet for the electronic device (a subnet when the electronic device 120 is in a home or office environment, as examples), as configured by the settings of the printer selection engine 126.

Pursuant to block 432, the printer selection engine 126 may then determine (block 432) the proximities based on the network subnets. In this manner, the printer selection engine 126 may determine that one or multiple printers 140 of the candidate printers 140 are within the same subnet 120 for the electronic device 120, and so forth.

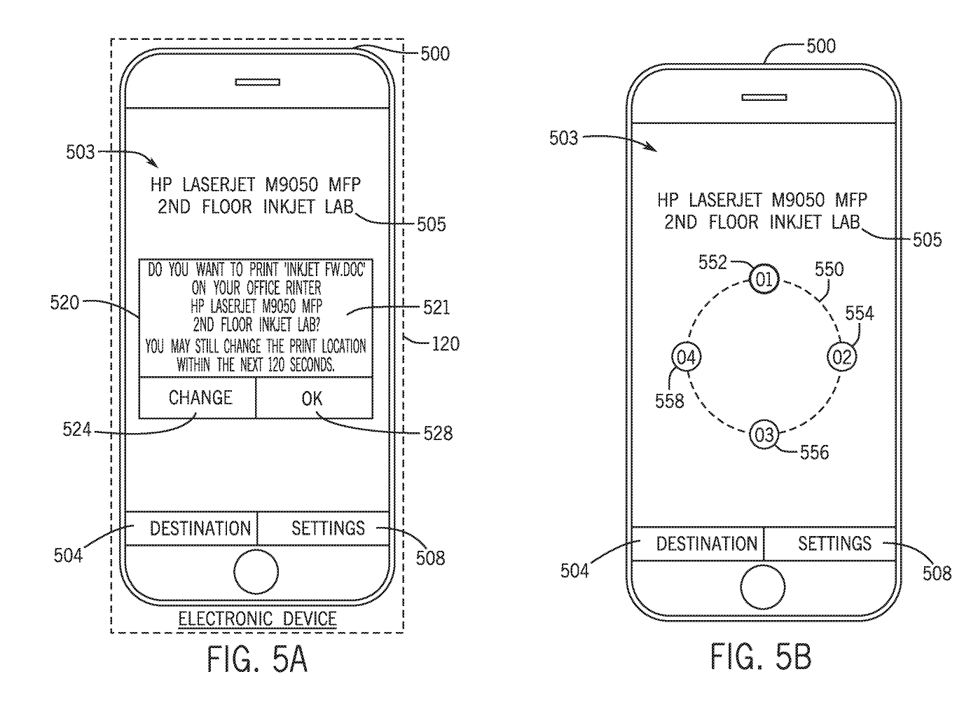

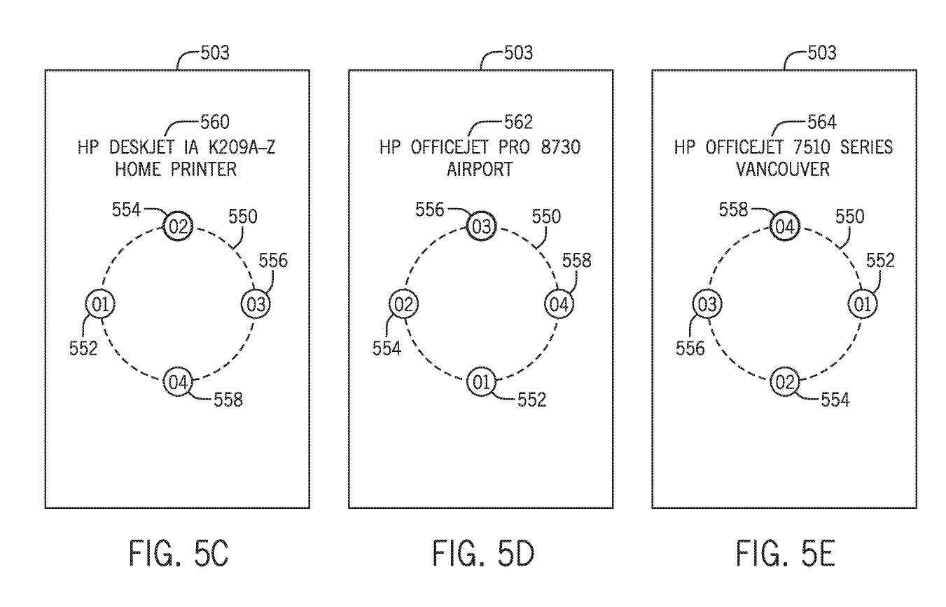

Referring to FIG. 5A in conjunction with FIG. 1, in accordance with example implementations, the electronic device 120 may be a mobile or portable device, such as a smartphone 500; and the printer selection engine 126 of the smartphone 500 may provide a GUI 503. The GUI 503 may display a DESTINATION selector 504 (allowing the user to enter a location for the smartphone 500 for purpose of printer selection) and a SETTINGS button 508 to configure settings for the printer selection engine 126 (such as settings to control which printers 140 may be considered candidate printers, based on smartphone 500 location, for example). For the example of FIG. 5A, the GUI 503 displays the printer selection engine's selection of a printer (here, a HP LaserJet M9050 MFP printer that is located on the second floor of a specific room, as represented by text 505) for a particular print job 130. In accordance with example implementations, along with the selection, the GUI 503 may display a window 520, which provides the user a predetermined time (120 seconds, for this example, as displayed in example message 521) to override the engine's selection and select another printer 140. In this manner, as depicted in FIG. 5A, a CHANGE selector 524 may be engaged to change the printer selection, and an OK selector 528 may be engaged to accept the printer selection engine's selection.

FIG. 5B depicts the GUI 503 after the printer selection engine's first selection has either been confirmed by the user pressing the OK selector 528 or the allocated time has elapsed. As shown, in accordance with example implementations, the GUI 503 may display a status indicator 550, which contains four icons 552, 554, 556 and 558 that represent the first, second, third and fourth priority printers 140, respectively, as assigned by the printer selection engine 126. The top icon (here, the icon 552 at the twelve o'clock position) of the status indicator 550 represents the printer (here the HP LaserJet M9050 MFP) to which the print job 130 is being routed.

For a wide variety of reasons, the print selection engine 126 may re-route a given print job 130 from the originally selected printer 140 and to another printer according to the priority order assigned by engine's ranking. For example, the first priority printer 140 may experience a media fault, the first priority printer may go offline due to an error, the first priority printer may take longer than a predefined user selected period for processing the print job 130, and so forth. Moreover, in accordance with example implementations, the user may direct the printer selection engine 126 to reroute the print job 130 to another printer 140.

FIG. 5C depicts the print job 130 being routed to the second priority printer 140 (here, an HP DeskJet IA K209A-Z printer that is located at the home of the user, as represented by text 560). FIG. 5D depicts the print job 130 being routed to the third priority printer 140 (here, an HP OfficeJet Pro 8730 printer that is located at the airport, as represented by text 562). FIG. 5D depicts the print job 130 being routed to the fourth priority printer 140 (here, an HP OfficeJet 7510 Series printer that is located in downtown Vancouver, as represented by text 564).

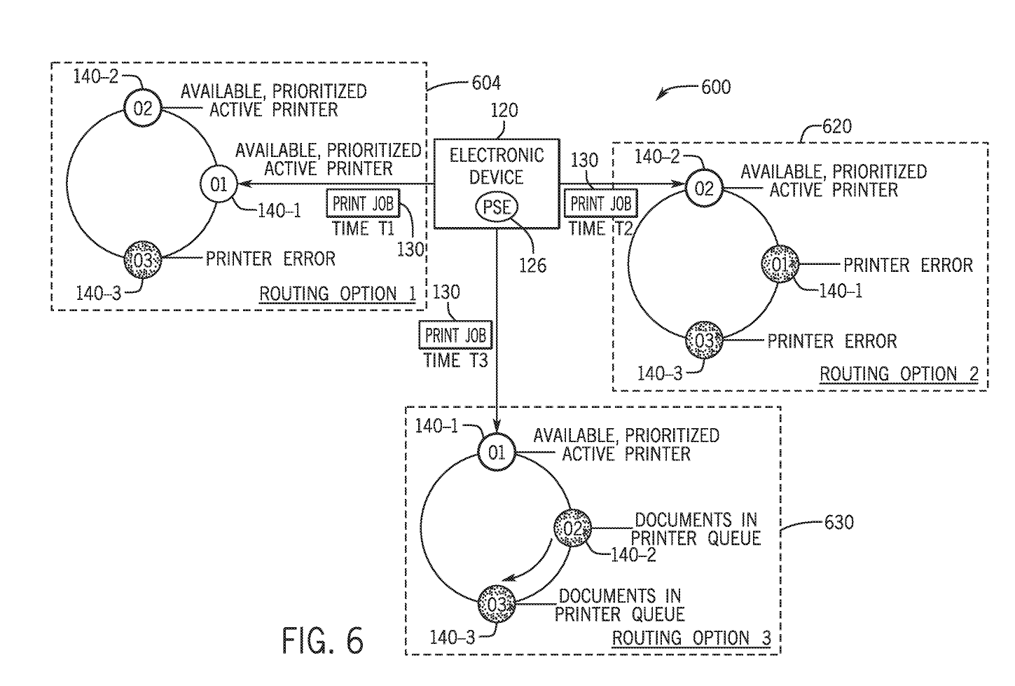

FIG. 6 is an illustration 600 of the routing/re-routing of a print job 130, in accordance with example implementations. This example depicts three options for routing/re-routing the print job 130: routing option one 604, routing option two 620 and routing option three 630, which are the options available at example times T1, T2 and T3, respectively. The three options 604, 620 and 630 involve the selection of one of the following printers 140: printer 140-1 (the first priority printer for this example), printer 140-2 (the second priority printer for this example) or printer 140-3 (the third priority printer 140 for this example). Initially, a time T1, option one 604 is exercised, and the print job 130 is routed to the first priority printer 140-1. As shown, at time T1, the third priority printer 140-3 experiences an error and thus, is unavailable, and the second priority printer 140-2 is available. Before the first priority printer 140-1 can process the print job 130, however, an error occurs, and in response to this error, the printer selection engine 126 exercises option two 620 and automatically reroutes the print job 130 to the second priority printer 140-2 at time T2. It is noted that for any of the routing/re-routing discussed in connection with FIG. 6, the user may be given an option to override the re-routing or guide the re-routing, as discussed above. As depicted in FIG. 6, at time T2, the first priority printer 140-1 experiences an (which caused the re-routing) error and thus, is unavailable, and the third priority printer 140-3 is still unavailable. Continuing the example, before the second priority printer 140-2 can complete the print job 130, an error occurs. However, the first priority printer 140-1 is now again available. The printer selection engine 126 evaluates the printer choices again, and as illustrated in FIG. 6, the printers 140-2 and 140-3 are now available but have documents in their respective printer queues. At time T3, the printer selection engine 126 exercises routing option three 630 and automatically reroutes the print job 130 to the first priority printer 140-1 (at time T1), where the print job 130 is completed.

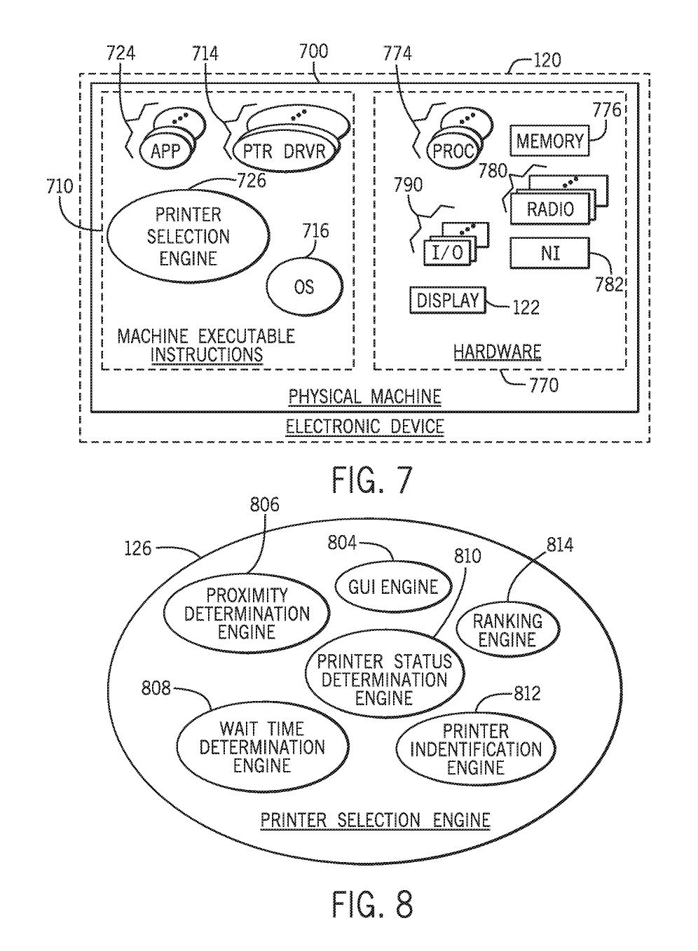

Referring to FIG. 7 in conjunction with FIG. 1, in accordance with example implementations, the electronic device 120 may be an actual physical machine 700 that is formed from machine executable instructions 710, or “software,” and actual hardware 770. As examples, the machine executable instructions 710 may include the instructions 714, 716, 724 and 726, that when executed by one or more processing cores 774 of the electronic device cause the processing core(s) 774 to form the printer drivers 125, an operating system, the applications 124 and the printer selection engine 126, respectively. The processing cores 774 may include, as examples, one or multiple central processing unit (CPU) cores, one or multiple graphic processing unit cores (GPU), and so forth, depending on the particular implementation. The hardware 770 may include a memory 776; and one or multiple radios 780 (a cellular radio, a GPS radio (used by the processor(s) 774 to determine a location of the electronic device 120, for example), a WiFi radio, and so forth). The processing core(s) 774 may execute the machine executable instructions 710 when stored in the memory 776. In general, the memory 776 is a non-transitory storage medium that may be formed from non-transitory semiconductor storage devices, memristors, phase change memory devices, magnetic storage devices, a combination of any of these devices, and so forth. As also depicted in FIG. 8, in accordance with some implementations, the hardware 770 may include hardware components, other processor(s) 774 and the memory 776, such as one or multiple network interfaces 782 (used by the processor(s) 774 to identify the printers 140); one or multiple input/output devices 790 (keyboards, touchscreens, buttons, and so forth); the display 122; and so forth.

In accordance with further example implementations, the printer selection engine 126 may be constructed as a hardware component that is formed from dedicated hardware (one or more integrated circuits that contain logic that is configured to perform a graph inference algorithm). Thus, the printer selection engine 126 may take on one or many different forms and may be based on software and/or hardware, depending on the particular implementation.

Referring to FIG. 8, in accordance with example implementations, the printer selection engine 126 may have various components. For example, in accordance with some implementations, the printer selection engine 126 may have a GUI engine 804, a proximity determination engine 806, a print wait time determination engine 808, and a printer status determination engine 810, a printer identification engine 812, a ranking engine 814, and so forth, which provide the functions for the engine 126, as described herein.

While the present techniques have been described with respect to a number of embodiments, it will be appreciated that numerous modifications and variations may be applicable therefrom. It is intended that the appended claims cover all such modifications and variations as fall within the scope of the present techniques.

1. A method comprising:
in an electronic device, in response to a print job, identifying active printers associated with a location for the electronic device, wherein the location is selected by user input to the electronic device; and
in the electronic device, prioritizing the identified active printers to process the print job based at least in part on the location for the electronic device and statuses associated with the printers.

2. The method of claim 1, wherein the prioritizing the identified active printers comprises ranking the printers based at least in part on hardware error statuses and media error statuses associated with the printers.

3. The method of claim 1, further comprising:
communicating with the identified active printers to determine wait times associated with the identified printers,
wherein prioritizing the identified printers further comprises prioritizing the identified printers based at least in part on the wait times.

4. The method of claim 1, further comprising:
selecting one of the printers to process the print job based at least in part on the prioritization.

5. The method of claim 1, further comprising:
displaying a list of the prioritized printers in a graphical user interface of the electronic device to allow selection of one of the printers to process the print job.

6. The method of claim 5, further comprising:
receiving a selection via the graphical user interface of the user selection of one of the printers; and
the electronic device overriding the selection in response to a determination that the selected printer has become unavailable.

7. The method of claim 6, further comprising:
in response to the overriding, providing an option in the graphical user interface for the user to select a printer other than the other printer selected due to the overriding.

8. The method of claim 1, wherein the electronic device identifying the printers comprises identifying printers associated with a future location for the electronic device.

9. An article comprising a non-transitory storage medium readable by a processor-based machine to store instructions that when executed by the processor-based machine cause the processor-based machine to:
identify candidate printers to process a print job for the processor-based machine based at least in part on a future location for the processor-based machine;
rank the candidate printers based at least in part on statuses of the printers and proximities of the candidate printers to the processor-based machine; and
select a printer from the candidate printers to process the print job based at least in part on the ranking.

10. (canceled)

11. The article of claim 9, the storage medium storing instructions that when executed by the processor-based machine cause the processor-based machine to:
determine a network subnet mask identification (ID) and identify the printers based at least in part on the determined subnet mask ID.

12. The article of claim 9, the storage medium storing instructions that when executed by the processor-based machine cause the processor-based machine to:
determine a location of a printer of the printers, comprising communicating with the printer to retrieve a location programmed in the printer.

13. An apparatus comprising:
a radio;
a communication interface; and
a processor to use the radio to determine a location of the apparatus and select a printer to process a print job, the processor to:
use the communication interface to at least attempt to communicate with a plurality of candidate printers to identify a set of printers of the plurality of candidate printers;
prioritize the identified set of printers to process the print job based at least in part on the location for the apparatus and statuses associated with the identified set of printers.

14. The apparatus of claim 13, wherein the processor ranks the identified set of printers based at least in part on hardware error statuses and media error statuses associated with the identified set of printers.

15. The apparatus of claim 13, wherein the processor filters the candidate printers to identify the set of printers based at least in part on a requirement associated with the print job.

16. The apparatus of claim 13, further comprising a housing, wherein the radio, the communication interface and the processor are contained in the housing.

17. The apparatus of claim 13, wherein the processor identifies the plurality of candidate printers based a set of printers for the location identified by user input.

18. The apparatus of claim 13, wherein the processor identifies the plurality of candidate printers based a set of printers identified by user input.

19. The apparatus of claim 13, wherein the radio comprises a global positioning satellite radio (GPS).

20. The apparatus of claim 13, wherein the processor identifies the plurality of candidate printers based a set of installed printer drivers.
